(19) United States
(12) Patent Application Publication
(10) Pub. No.: US 2003/0014419 A1
(43) Pub. Date: Jan. 16, 2003

(54) Compilation of fractional media clips

(76) Inventor: Edward O. Clapper, Tempe, AZ (US)

Correspondence Address: TROP PRUNER & HU, PC, 8554 KATY FREEWAY, SUITE 100, HOUSTON, TX, 77024, US

(21) Appl. No.: 09/902,911

(22) Filed: Jul. 10, 2001

(51) Int. Cl. G06F 7/00

(52) U.S. Cl. 707/101

(57) ABSTRACT

A method of reconstructing an original block of data, such as a recording of a song, from two or more clips or instances of the song, by locating and identifying overlapping sub-clips in respective clips and merging them to create a new version of the original block. The new version can be superior to any of the clips, by culling the best pieces from each. Partial clips can be used, as can damaged or defective clips.

### BACKGROUND OF THE INVENTION

1. Technical Field of the Invention

The present invention relates generally to reconstruction or repair of sequences of data. The illustrated embodiment is adapted for use on audio or video data.

2. Background Art

In the biological sciences, a new technique has been created, known as gene sequencing. Biological scientists are able to reconstruct a lengthy sequence of genes, using only fragments of those genes, by identifying matching sub-sequences in two or more fragments, and, based upon those matching sub-sequences, appending or concatenating the fragments (minus duplicative overlapping sub-sequences, of course).

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 shows one embodiment of a system constructed according to this invention.

FIGS. 2A-B show a heuristic example of a data sequence reconstruction according to this invention.

FIG. 3 shows a heuristic example of a data sequence repair according to this invention.

FIG. 4 shows one embodiment of a method of reconstruction.

FIG. 5 shows one embodiment of a method of repair.

FIG. 6 shows another embodiment of a method of repair.

### DETAILED DESCRIPTION

For simplicity of explanation and ease of comprehension, the invention will be explained in terms of a system for repairing or reconstructing audio or video blocks from audio or video clips. A “block” may be, for example, an audio song, an audio album, a television show, a movie, or other such item, while a “clip” may be any subset of such, or, more particularly, any sequential data subset of such. The skilled reader will appreciate that this example is only for teaching purposes, and is not intended to limit the scope of the invention. For example, the invention may readily be applied to reconstructing or repairing computer data files, text documents, databases, spreadsheets, or any other thing which is represented by an ordered sequence of data. The invention will be explained in terms of digital data, but is readily employable in the repair or reconstruction of analog data items, as well.

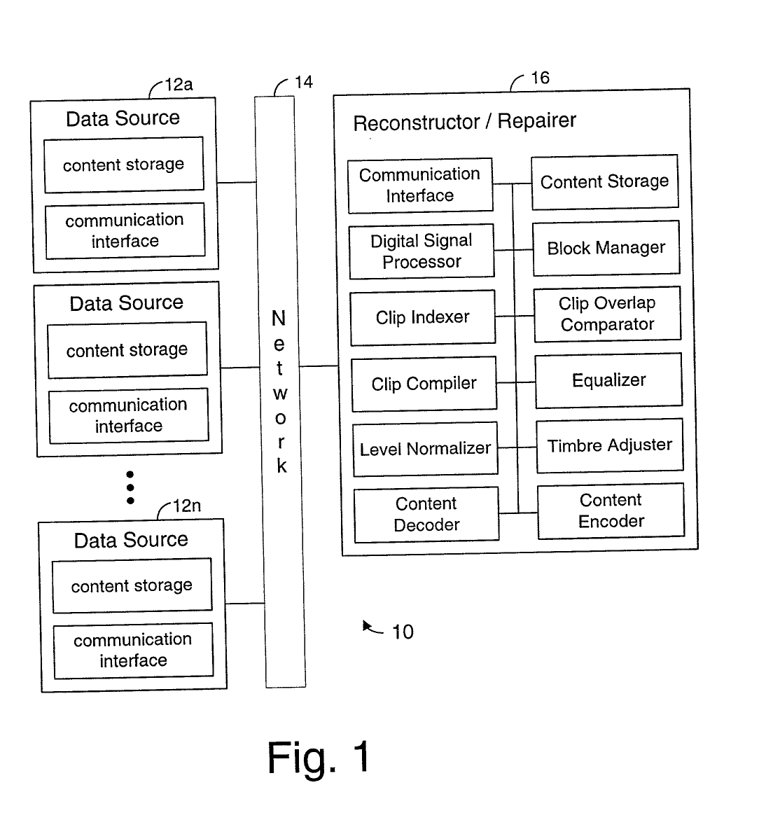

FIG. 1 illustrates one embodiment of a system 10 such as may be constructed utilizing the principles of this invention. The system includes one or more data sources 12a-n which may suitably be coupled together over a network 14. The topology, signaling protocol, and so forth of the network are not particularly germane to the application of the invention, and thus will not be discussed; suffice it to say that the network could include one or more of point-to-point signaling, peer-to-peer computing, server-client networking, local area networking, wide area networking, cable, wireless, cellular, satellite, local storage, and so forth.

Each data source includes a communication interface appropriate for its particular connectivity to the network, and a content storage in which it may store data, which data may include blocks and/or clips.

The reconstructor or repairer 16 (which may, in some embodiments, itself be one of the data sources 12) includes a content storage for storing blocks and clips, and a suitable communication interface. In some embodiments, the reconstructor further includes a digital signal processor (DSP) for performing DSP operations upon the block and clips, a block manager, a clip overlap comparator, a clip indexer, and a clip compiler. In some embodiments, the DSP may be a dedicated DSP unit, while in others, it may be a general purpose processor equipped with software embodying the DSP functionality. The repairer may optionally also include a content decoder and a content encoder for converting e.g. between analog and digital formats, a level normalizer, an equalizer, and a variety of other content manipulation mechanisms represented herein by way of illustration as a timbre adjuster. The reader will appreciate that any one or more of these features may be implemented in hardware, software, firmware, control codes, and the like, or hybrids thereof. In various embodiments, various ones of them may be built using analog techniques, while in other embodiments, various ones of them may be built using digital techniques.

The reader will understand that the specific interconnections between these items need not necessarily be exactly as illustrated, and that the illustration is merely for teaching purposes. The skilled engineer will readily identify many possible configurations suitable for a particular application.

In some instances, the repairer may have in its storage or otherwise available to itself, a sufficient supply of clips from which it may repair or reconstruct the block in question. In such instances, the network and other data sources need not be present or utilized.

In some implementations, the apparatus may include a mechanism for enabling user manipulation or customization of the process. In some such embodiments, this may be accomplished via a graphical user interface, using conventional techniques.

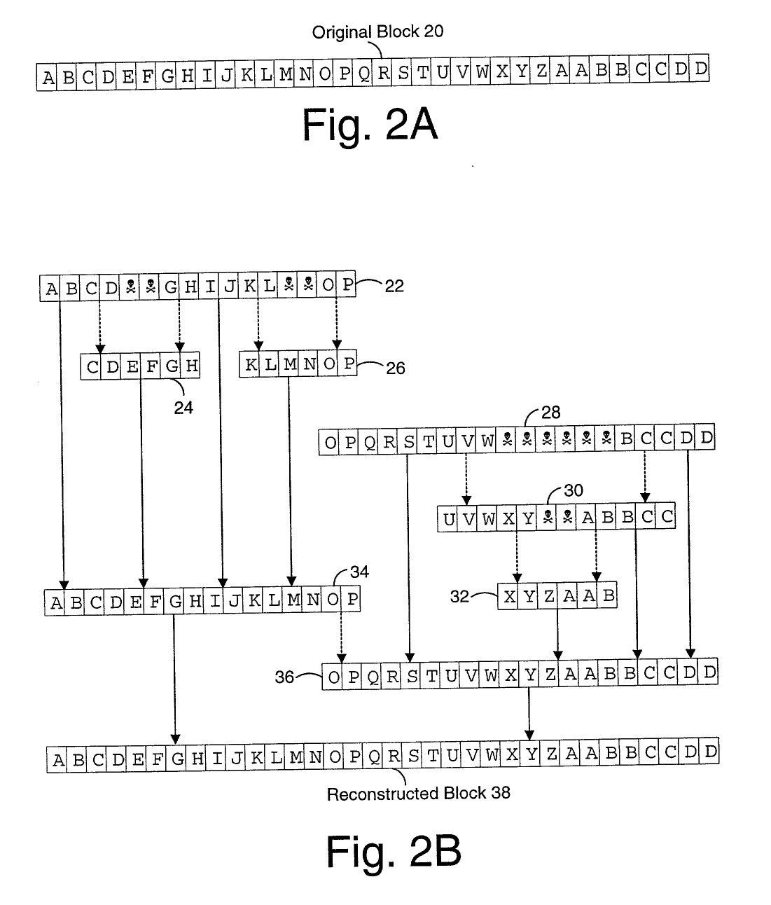

FIGS. 2A and 2B illustrates a reconstruction operation which may be performed by the invention. Please continue throughout this document to continue referring also to FIG. 1. For purposes of illustration, dashed arrows in FIG. 2B illustrate the identification by the clip overlap comparator of matching sub-clips, while the solid arrows illustrate the copying by the clip compiler of clips to create larger or more correct clips.

It is desired to reconstruct an original block 20, such as a song, but the complete data sequence representing the original block is not known to be suitably available from any one source. However, the reconstructor has in its storage, or obtains from a data source 12a-n, a first clip 22 which is known or believed to be from the original block. This knowledge or belief may be based upon external input, such as human intervention, or upon internal input such as data in the clip itself (e.g. in the case of an MP3 clip, the song title and artist may be encoded in the clip).

The block manager specifies, based on this external or internal input, the block to be reconstructed, and causes the clip indexer and clip compiler to begin building on this first clip 22. The DSP, under control of the clip indexer and clip overlap comparator, begins hunting through the various clips which are in the clip storage or which are received over the communication interface. The reader will appreciate that these mechanisms may make use of any suitable DSP techniques or other data calculation techniques. These techniques may generate data representative of various features of the clips, such as, in the case of audio: melody, harmony, tempo, rhythm, frequency spectrum, intonation, tonality, timbre, echo, discrete cosine transformation (DCT) of such, fast Fourier transform (FFT) of such, and so forth; or in the case of video: color, frame size, frame rate, motion, encoding technique, hue, intensity, saturation, white balance, encoding technique, DCT or FFT of such, and so forth.

These techniques may be applied over a clip in its entirety, or they may be applied to sub-clips of fixed or of variable size. These sub-clips are generally represented by the data pieces labeled “A”, “B”, and so forth. The reader will understand that the value e.g. “A” may represent either the actual data values (digital or analog) in that portion of the clip, or it may represent the result of the DSP operation upon the actual data values, such as the DCT output or such as a hash or cyclic redundancy check (CRC) value representing the actual data values.

The details of the clip indexer are well within the abilities of those of ordinary skill in the art, and will not be recited at any great length herein. Suffice it to say that the clip indexer keeps track of which clips are known, which clips are needed, and so forth, using any conventional mechanism such as tables, linked lists, or other suitable means. The clips may be indexed or located based upon any suitable parameter, such as a hash value, an offset into their overall block, their first few bytes' values, a DSP output based on the first few seconds of the clip, or the like. The clip indexer may index entire clips each as a whole, and/or it may keep track of sub-clips within them, as needed.

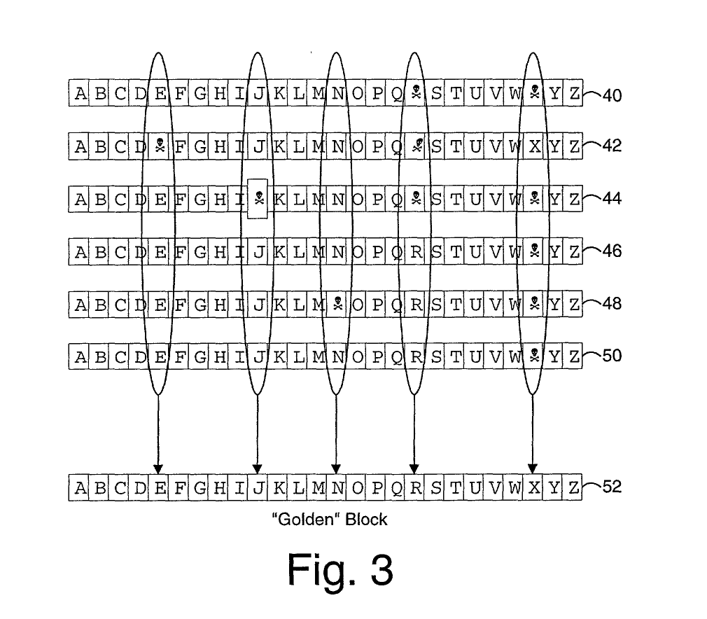

As illustrated in FIG. 2B, it may in some cases be possible to have a clip with one or more sub-clips that contain garbage, illustrated by the poison symbol. For purposes of explanation, assume for now that these are known bad data (although as will be seen in the discussion of FIG. 3, below, that is not necessarily the case).

The DSP, under control of the clip indexer and clip overlap comparator, eventually locates a second clip 24 which “matches” a portion of the first clip 22. In the case shown, it matches at both its start (“CD”) and its end (“GH”). The clip compiler is thus able to replace the known bad portion of the first clip between these matching points, by copying the “AB” from the first clip, the “CDEFGH” of the second clip, and the “IJ” of the first clip, to a result clip 34. The DSP also finds a third clip 26 which matches another portion of the first clip, and the clip compiler is then able to continue building the result clip 34, in similar fashion, continuing from “IJ” to “OP”.

The reconstructor also has access to a fourth clip 28, either in its storage or over its communication link, which it knows from either internal or external input to relate to the original block. It finds matching clip 30 which enables the repair of part, but not all of the known bad data in the fourth clip 28. It also finds matching clip 32 which enables the repair of the rest of the bad data. Note that, as illustrated, the clip 32 could not have been matched against the clip 28, without the intervening repair per clip 30. The clips 28, 30, and 32 enable the creation of clip 36.

Finally, the clip overlap comparator is able to determine (based on the matching “OP” sub-clips) that the clip compiler should combine clips 34 and 36 to create the reconstructed block 38. The block manager may then file the reconstructed block away for future use.

The reader will appreciate that it is only for the sake of convenience in illustration that the matches have been illustrated as matching over two adjacent sub-clips (such as “CD”).

FIG. 3 illustrates use of the invention in repairing a block, as somewhat opposed to the operation of FIG. 2 which more illustrates reconstruction of a block. The skilled reader will appreciate that these techniques may readily be practiced in tandem, and that they are illustrated separately merely for clarity of explanation.

The reconstructor, or in this case repairer, has access to a plurality of blocks 40-50, either in its own storage or from other data sources over the network via its communication interface. In FIG. 3, the reader will appreciate that the poison symbol does not necessarily represent known-bad data, nor necessarily even data that are the same as at the other poison symbols, even within the same sub-clip location (column).

The clip comparator compares the blocks, and identifies locations at which they are different. These locations are likely to contain errors in one or more of the blocks. Such errors might include, for example, clicks, pops, scratches, dropouts, warping, lost bits, mastering errors, incomplete transmissions, snow, broadcast saturation, data corruption, and so forth.

In many positions, such as “A” through “D”, the blocks are in agreement, and the clip overlap comparator, clip compiler, and DSP can simply copy those values into their respective positions in the creation of a “golden” block 52. In this context, “copy” may mean the generation of a new set of values, such as an average of the plural existing instances of each sub-clip. Or, it might literally be a copying from one of the sub-clips.

In the “E” position, the DSP observes that five of the blocks agree on the value “E”, but the sixth (42) has different data. The DSP may thus select a value (“E”) according to a majority of the blocks, for inclusion in the golden block at that position.

The “J” position is meant here to illustrate the principle that the “position” of data need not necessarily in all cases be restricted to a strict lineal offset from the start. In the illustrated case, the “J” position of the block 44 is actually a different size than the sub-clips at the “J” position in the other blocks. It may even be null, with zero length. However, the clip overlap comparator and clip indexer will realize that the clips have matching values “HI” and “KL”, and that only one of the clips has a different quantity of data between those values, and that it is thus likely that that block 44 simply has an error. In this case, the value “J” present in the other clips will be included in the golden block.

The “R” position is meant here to illustrate the principle that it is not necessary to have a large majority decision, in order to determine a golden value. Three blocks 46, 48, and 50 contain matching values “R”, while the other blocks contain values other than “R” and which may differ from each other. In this case, “R” is selected for inclusion in the golden block.

The “X” position is meant here to illustrate the principle that a decision may even be made based upon a minority, or in the extreme case, upon a single block 42. In some cases, based upon some known aspect of the nature of the type of block under repair, it may be known that certain characteristics of data are expected and likely. For example, it may be known that the blocks contain an English language text file. If the “X” position is different as between all the blocks, but only one of those sub-clips (the one in block 42) contains text which passes an English spelling check, that sub-clip may be selected with confidence. In fact, it may be thus selected even if two or more of the other blocks′ corresponding sub-clips match each other; in that case, the matching majority is simply bogus data.

Other forms of context-sensitive selection rules may be employed by the DSP, clip compiler, etc. For example, in the case of an audio recording, the DSP may make an analysis of the prior sub-clip “W” and subsequent sub-clip “Y”, to determine an expected general value or quality of the sub-clip “X” in question. For example, if “W” and “Y” are determined to represent music having large low-frequency content and a heavy beat, and only the block 42 has an “X” position content that has large low-frequency content and a heavy beat, the clip complier may select that sub-clip for inclusion in the golden block.

FIG. 1 illustrates additional features which may optionally be employed in combination with the mechanisms described above. In the typical case, where the various blocks are taken from different external sources such as multiple data sources 12a-n, the blocks are likely to have been created on different equipment. The blocks are therefore likely to have different quality and characteristics that are dependent upon their source equipment as well as their source media. For example, a first copy of a song may have been captured from a scratchy vinyl record (the media) played on a slightly over-speed record player with a worn needle and a weak pre-amp onto a worn cassette tape (the equipment). A second copy of the song may have been digitally captured from a radio broadcast of a compact disc, while the disc jockey was speaking over part of the song. In addition to the media-dependent differences (such as the clicks and pops from the scratches on the record), these two blocks will have equipment-dependent differences (such as gain or volume, frequency equalization shape, playback speed and duration, timbre, and so forth).

The level normalizer, equalizer, timbre adjuster, and DSP may be utilized to conform the various blocks to each other or to some ideal, either in whole or in part. For example, in FIG. 3, if the system determines that the first block 40 is the “best”, when the “X” sub-clip of block 42 is selected for inclusion in the golden block, it may be desirable to match that “X” sub-clip to the frequency equalization, timbre, volume level, etc. of the first block 40. This will prevent or at least reduce distracting changes in the audio “character” as playback of the golden block enters and leaves sub-clip “X”.

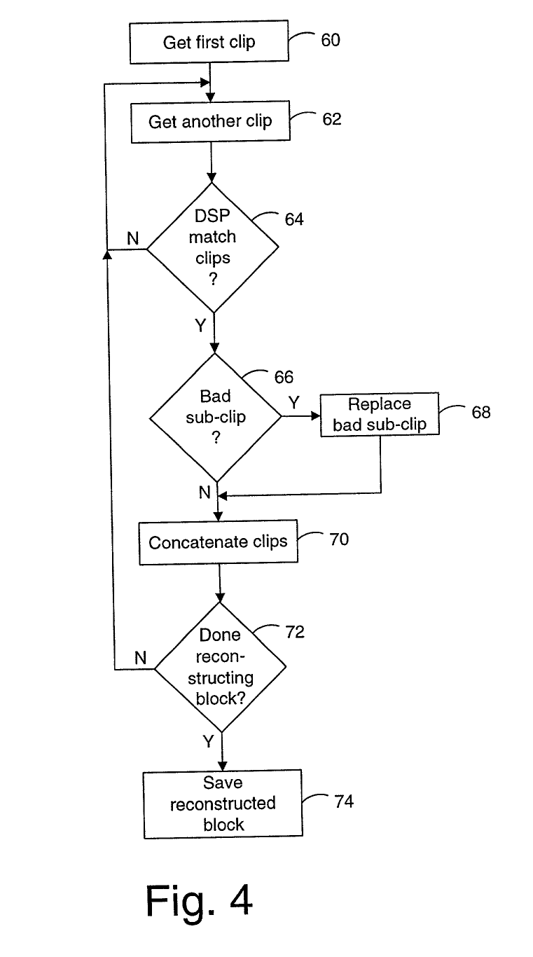

FIG. 4 illustrates one exemplary embodiment of a method for reconstructing a block. The reconstructing data source gets (60) a first clip from its storage or via its communication interface. It then gets (62) a second clip, and attempts (64), using its DSP mechanisms, to determine whether the clips have any overlapping segments. If not, it returns to getting more clips to compare against the first clip. But if there is a matching overlap, it determines (66) whether there is one (or more) bad sub-clip in the first clip which can be replaced with better data from the other clip. If so, the bad sub-clips are replaced (68). The good segments of the clips are appended or concatenated (70) to create a larger or at least better clip. If (72) the reconstruction of the block is complete, the reconstructed block is saved (74) for future use. Otherwise, operation returns to looking for additional clips to compare against for further reconstruction. In many cases, the concatenated clips will match against other clips which the first clip or even the intervening clips would not have matched. By iterative attempts, the method builds an ever-improving reconstructed block, until the block has been completely reconstructed or until no further matching clips are available.

The reader will appreciate that this is but one simplistic example, and that the skilled engineer will be able, armed with this disclosure, to embody this invention in a variety of methods having different decision criteria, different control flow, and different operations.

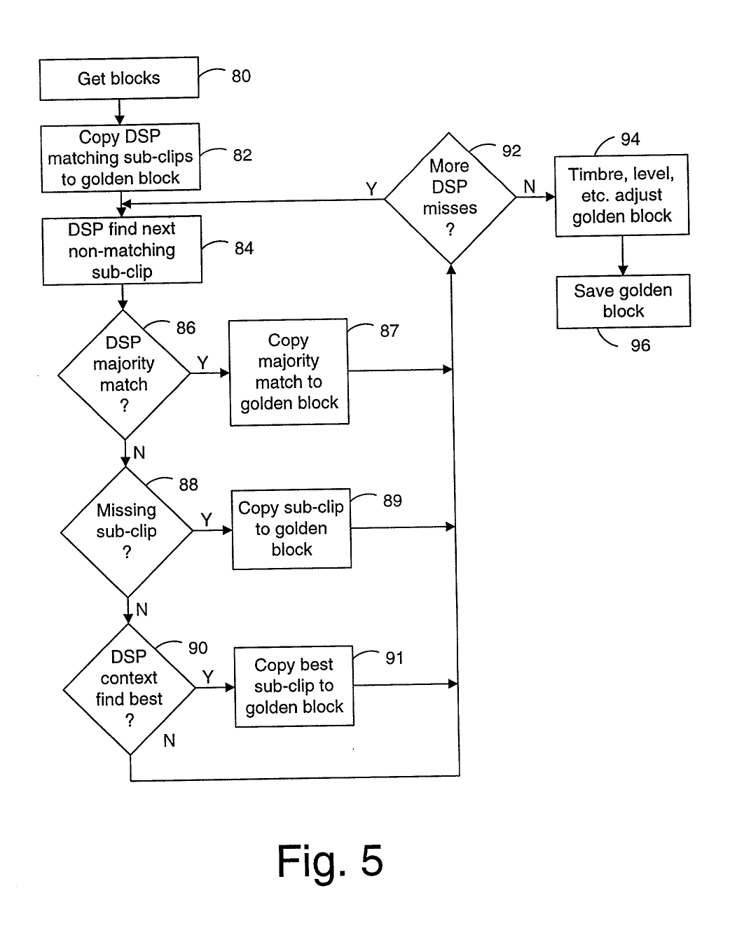

FIG. 5 illustrates one exemplary embodiment of a method for creating a golden block by repairing one or more lesser-quality blocks. The reconstructing data source gets (80) two or more blocks, variously from its storage and/or its communication interface. Sub-clips which are found to be matching between the blocks are copied (82) to the golden block. A non-matching sub-clip is found (84); that is, a sub-clip which has different values or lengths as between the various blocks. If (86) the majority of the blocks are in agreement as to the content of that sub-clip, their version of the sub-clip is copied (87) to the golden block. If (88) a missing sub-clip is detected in some blocks but found in others, the found sub-clip is copied (89) to the golden block. In some applications, it may be possible to identify (90) a “best” or most likely sub-clip based on the context of the overall block or of the surrounding sub-clips, for example. In such case, that sub-clip is copied (91) to the golden block. If (92) there are more defects, operation returns to finding the next such defect. Otherwise, the golden block has been completely assembled, and can now be fixed (94) as to such characteristics as timbre, recording level, and so forth, to make a more cohesive, pleasing whole out of the various sub-clips which have come from various sources. Finally, the golden block is saved (96) for future usage.

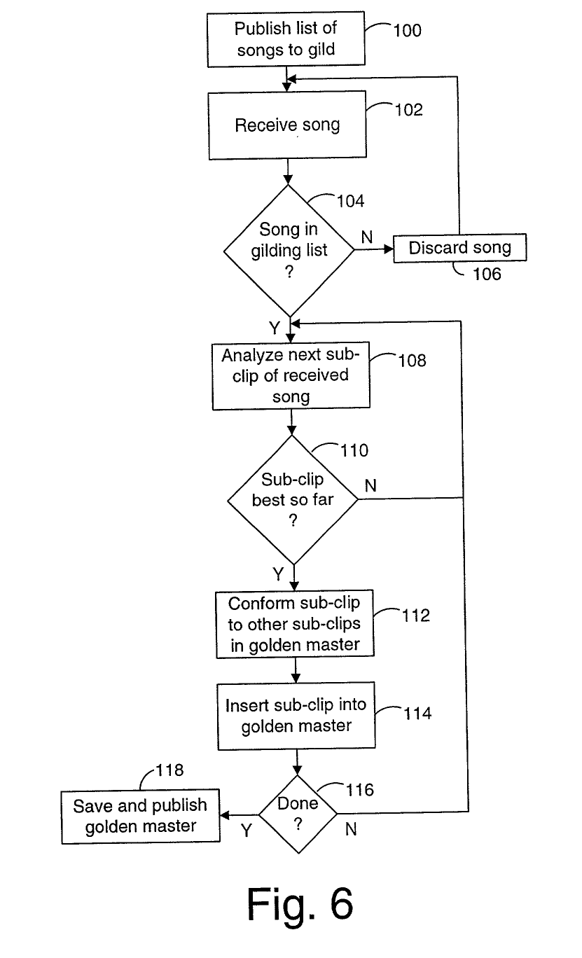

FIG. 6 illustrates another exemplary embodiment of a method for creating a golden block. The example is given with reference to a song. The user or repairer publishes (100) a list of songs to “gild” or, in other words, of which to create golden masters. In one mode, this may be a passive publication such as by posting a list to a website. In another mode, it may be published using a mechanism such as that of Napster or Scour or the like. In another mode, it may be “pushed” to potential sources of copies or instances of the song. In one mode, the list is a textual list of, for example, the song's title, artist, album name, unique identification number, recording date, pressing master identifier, record label, songwriter, recording venue, and/or other suitable information. In another mode, it might be, for example, a hash value or digital signal processing result of some computation or operation upon the content of the song or some portion thereof. For example, it might be a DSP output representing the first five seconds of the recording.

After using the published list's contents as appropriate (such as by searching computer filenames for a matching string, or by performing similar DSP operations upon their locally stored songs), one or more of these sources responds by sending their copies of the song, which are received (102) by the repairer. In some embodiments, the repairer may be a local user's computer. In other embodiments, it may be a central agency such as Napster.

The repairer confirms (104) that the received song is in its list, and, if not, it discards (106) the song. Alternatively, it might cache the song in case it is needed in the future. Alternatively, it might simply add that song to its list.

The repairer analyzes (108) a next sub-clip of the song, such as by performing DSP operations on it. If (110) this sub-clip is not better than corresponding sub-clips of previously-analyzed instances of the song, it does not contribute to the “goldenness” of the master, and is ignored, with operation returning to analysis of a next sub-clip. If it is the best of the corresponding sub-clips seen so far, it will be used in creating or improving the golden master. In order to create the most audibly pleasing golden version of the song, it is desirable to conform (112) the sub-clip to the other sub-clips already in the master. This may include, for example, level adjusting, timbre adjusting, equalizing, and so forth. Alternatively, the golden master may be conformed as a unitary whole at some future point, such as when it has been completed.

The newly-found best sub-clip is added (114) to the golden master. It may replace a previously-found then-best sub-clip.

If (116) there are no more sub-clips in the instance of the song under analysis, the golden master is complete and may be saved (118) and published. Otherwise, operation continues at the next sub-block.

It is not strictly necessary that the method of FIG. 6 be performed a single song at a time, nor even a single instance/copy of a song at a time. In many embodiments, it will be desirable to gather a plurality of copies of a particular song before beginning operation, to create a best possible golden master. For example, in order to reduce distortion and inaccuracy that might be introduced by conforming individual sub-clips from a wide variety of copies of the song, it may be desirable to identify one “best copy” of the song and use the other copies to fix sub-clips in that “best copy”, and to perform all conformation operations (e.g. timbre, level, and equalization) against the other sub-clips in the “best copy” rather than those in a constructed-on-the-fly golden master.

In some instances, it may be suitable to publish the list of songs by publishing sets of known sub-clips. For example, referring again to FIG. 2, the repairer could broadcast “I have a clip ABCD [symbol] [symbol] GHIJKL [symbol] [symbol] OP and I need to repair the [symbol] [symbol] portions” or “I have a clip ending in LMNOP and need to continue building from the OP”. The other data sources may then go searching through their storage for instances of “ABCD” or “CD<anything>GH” or “OP<anything>” or the like, and may send the matching sequences to the repairer.

The reader will appreciate that the skilled engineer will be able to embody this invention in a variety of such methods, having different decision criteria, different control flow, and different operations. The example given is for illustration only, and is not limiting on the scope of the invention.

While the invention has generally been illustrated in terms of the repair and reconstruction being done at a single agent, the reader will appreciate that the invention may well be used in a peer-to-peer or distributed computing environment. In some such embodiments, a portion of the clip processing may be done at e.g. a client, and the remainder of the clip processing may be done at e.g. a server. For example, a client could perform clip indexing, and leave the clip compilation to the server. Alternatively, the client could perform clip indexing and compilation, and the server could perform aggregation of a golden master, or inter-clip audio normalization, or the like.

The reader will further appreciate that various business models may be constructed around and utilizing this invention. For example, consider the case of a record label which has lost one or more master recordings in a fire. The only existing copies of this recording may be records purchased by the public over several years, and now in various stages of decline. The record company might post a reward for the member of the public who uploads the copy of the recording which makes the largest contribution to the golden master, and may also offer free new copies made from the golden master to all who uploaded copies.

Finally, the reader will appreciate that while, in some applications, the invention may make use of digital signal processing techniques, other applications may make do without such techniques. For example, the reconstruction or repair of text files may be done using only conventional digital computing hardware, without a DSP.

The reader should appreciate that drawings showing methods, and the written descriptions thereof, should also be understood to illustrate machine-accessible media having recorded, encoded, or otherwise embodied therein instructions, functions, routines, control codes, firmware, software, or the like, which, when accessed, read, executed, loaded into, or otherwise utilized by a machine, will cause the machine to perform the illustrated methods. Such media may include, by way of illustration only and not limitation: magnetic, optical, magneto-optical, or other storage mechanisms, fixed or removable discs, drives, tapes, semiconductor memories, organic memories, CD-ROM, CD-R, CD-RW, DVD-ROM, DVD-R, DVD-RW, Zip, floppy, cassette, reel-to-reel, or the like. They may alternatively include down-the-wire, broadcast, or other delivery mechanisms such as Internet, local area network, wide area network, wireless, cellular, cable, laser, satellite, microwave, or other suitable carrier means, over which the instructions etc. may be delivered in the form of packets, serial data, parallel data, or other suitable format. The machine may include, by way of illustration only and not limitation: microprocessor, embedded controller, PLA, PAL, FPGA, ASIC, computer, smart card, networking equipment, or any other machine, apparatus, system, or the like which is adapted to perform functionality defined by such instructions or the like. Such drawings, written descriptions, and corresponding claims may variously be understood as representing the instructions etc. taken alone, the instructions etc. as organized in their particular packet/serial/parallel/etc. form, and/or the instructions etc. together with their storage or carrier media.

The reader will further appreciate that such instructions etc. may be recorded or carried in compressed, encrypted, or otherwise encoded format without departing from the scope of this patent, even if the instructions etc. must be decrypted, decompressed, compiled, interpreted, or otherwise manipulated prior to their execution or other utilization by the machine.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A method of reconstructing an original block of data, the data comprising at least one of audio data, video data, and a computer file, the method comprising:
accessing a plurality of data clips;
identifying matching sub-clips in two of the plurality of data clips;
aligning the two data clips at the matching sub-clips; and
appending the two aligned data clips and including a single instance of the matching sub-clip.

2. The method of claim 1 wherein appending comprises:
concatenating the two aligned data clips; and
omitting a second instance of the matching sub-clip.

3. The method of claim 1 wherein the appending comprises:
substituting data in a first of the two data clips with data in a second of the two data clips.

4. The method of claim 1 wherein the accessing comprises:
receiving at least one of the plurality of data clips over a communication link.

5. The method of claim 1 wherein the accessing comprises:
retrieving at least one of the plurality of data clips from local storage.

6. The method of claim 1 wherein the identifying comprises:
performing digital signal processing operations upon the plurality of data clips.

7. A method comprising:
accessing a plurality of blocks of data, the data comprising at least one of audio data, video data, and a computer file;
performing digital signal processing operations to identify at least one first sub-clip which is substantially dissimilar in a first of the plurality of blocks than in a second of the plurality of blocks, and at least one second sub-clip which is substantially similar in at least two of the plurality of blocks; and
responsive to the digital signal processing operations,
copying the at least one second sub-clip to a golden block,
determining which of the first and second of the plurality of blocks has a first sub-clip that is superior to the first sub-clip of the other of the first and second of the plurality of blocks, and
copying the superior sub-clip to the golden block.

8. The method of claim 7 wherein:
the determining comprises identifying a sub-clip containing defective values.

9. The method of claim 8 wherein:
the identifying the sub-clip containing defective values comprises performing digital signal processing operations on sub-clips.

10. The method of claim 7 wherein:
the determining comprises performing a majority operation across corresponding sub-clips of the plurality of blocks.

11. The method of claim 7 wherein:
the identifying the sub-clip containing defective values comprises identifying a null sub-clip indicative of missing values.

12. An apparatus comprising:
a digital signal processor;
a content storage capable of storing a plurality of blocks of data, the data comprising at least one of audio data, video data, and a computer file;
a block manager;
a clip overlap comparator; and
a clip compiler.

13. The apparatus of claim 12 further comprising:
a communication interface capable of receiving blocks of data comprising at least one of audio data, video data, and a computer file.

14. The apparatus of claim 13 further comprising:
a level normalizer.

15. The apparatus of claim 14 further comprising:
an equalizer.

16. The apparatus of claim 15 further comprising:
a timbre adjuster.

17. A system comprising:
a network;
a plurality of data sources each including,
content storage storing at least one block of data, and
a communication interface coupled to the network;
at least one of the data sources further including,
a digital signal processor,
a block manager,
a clip overlap comparator, and
a clip compiler.

18. The system of claim 17 wherein the at least one of the data sources further includes:
a level normalizer; and
an equalizer.

19. The system of claim 18 wherein the at least one of the data sources further includes:
a timbre adjuster.

20. A method of restoring a data block, the data block including at least one of audio and video data, the method comprising:
identifying a plurality of data blocks each available from a respective data source coupled to a network; and
creating a golden block by,
analyzing sets of corresponding sub-clips from respective ones of the plurality of data blocks,
responsive to the analyzing, for a first given set of corresponding sub-clips which the analysis indicates are substantially similar, generating in the golden block a sub-clip substantially similar to the first given set,
responsive to the analyzing, for a second given set of corresponding sub-clips which the analysis indicates are not substantially similar, generating in the golden block a sub-clip substantially similar to a sub-set of the second given set.

21. The method of claim 20 wherein the analyzing comprises:
performing digital signal processing operations.

22. The method of claim 20 wherein the generating the sub-clip substantially similar to the sub-set of the second given set comprises:
identifying a majority of the sub-clips in the second given set as being substantially similar to each other; and
generating in the golden block a sub-clip substantially similar to the majority.

23. The method of claim 20 wherein the generating the sub-clip substantially similar to the sub-set of the second given set comprises:
identifying a most common sub-clip in the second given set; and
generating in the golden block a sub-clip substantially similar to the most common sub-clip.

24. The method of claim 20 wherein the generating the sub-clip substantially similar to the sub-set of the second given set comprises:
identifying one of the blocks as having a sub-clip which is more similar to other sub-clips in the one block, than corresponding sub-clips in other blocks are to other sub-clips in those respective other blocks; and
generating in the golden block a sub-clip substantially similar to the sub-clip which is more similar.

25. The method of claim 20 wherein the generating the sub-clip substantially similar to the sub-set of the second given set comprises:
identifying a null sub-clip in one of the blocks; and
generating in the golden block a sub-clip substantially similar to a sub-clip in another of the blocks.

26. A method of generating a golden master of an audio recording, the method comprising:
comparing corresponding instances of sub-clips of the audio recording from a plurality of sources of instances of the audio recording; and
for each respective sub-clip, generating a sub-clip in the golden master substantially similar to at least one corresponding instance of the respective sub-clip.

27. The method of claim 26 wherein the generating comprises:
identifying a most common instance of the respective sub-clip; and
generating the sub-clip in the golden master in response to the most common instance.

28. The method of claim 27 wherein the identifying the most common instance comprises:
identifying a majority sub-clip.

29. The method of claim 26 wherein:
the comparing includes identifying an instance of the sub-clip having lesser audio distortion than another instance of the sub-clip; and
the generating includes creating the sub-clip in the golden master in accordance with the identified instance having lesser audio distortion.

30. The method of claim 29 wherein:
the audio distortion includes at least one of click, pop, wow, and flutter.

31. The method of claim 26 further comprising:
receiving the plurality of instances of sub-clips from the plurality sources over a communication interface.

32. The method of claim 31 wherein the receiving comprises:
receiving intact instances of the audio recording from the plurality of sources over the communication interface.

33. The method of claim 26 further comprising:
receiving, over a communication interface from the plurality of sources, a plurality of digital signal processing results representing respective instances of the sub-clips.

34. The method of claim 26 further comprising:
distributing the golden master over a communication interface.

35. The method of claim 26 further comprising:
altering an audio characteristic of a first sub-clip in the golden master to increase audio similarity of the first sub-clip to other sub-clips in the golden master.

36. The method of claim 35 wherein:
the altering includes at least one of normalizing level, equalizing, and adjusting timbre.

37. The method of claim 26 further comprising:
receiving an identification of the audio recording; and
using the identification in requesting the instances of sub-clips from at least one source.

38. The method of claim 37 wherein:
the requesting comprises requesting from remote sources over a network.

39. The method of claim 37 wherein:
the requesting the instances of sub-clips comprises requesting instances of the audio recording.

40. The method of claim 39 wherein:
the requesting comprises requesting from remote sources over a network.

41. The method of claim 36 wherein:
the sub-clips further comprise video data; and
the golden master further comprises video data.

42. The method of claim 36 further comprising:
indicating to external sources at least one known sub-clip and an identification of at least one desired sub-clip.

43. The method of claim 42 further comprising:
receiving a clip from an external source;
finding the known sub-clip in the clip received from the external source; and
responsive to the finding, obtaining the desired sub-clip from the clip received from the external source.

44. An article of manufacture bearing machine-accessible instructions which, when accessed by a machine, cause the machine to:
perform the method of claim 1.

45. The article of manufacture of claim 44 further bearing instructions which, when accessed by the machine, cause the machine to:
perform the method of claim 2.

46. An article of manufacture bearing machine-accessible instructions which, when accessed by a machine, cause the machine to:
perform the method of claim 7.

47. The article of manufacture of claim 46 further bearing instructions which, when accessed by the machine, cause the machine to:
perform the method of claim 9.

48. An article of manufacture bearing machine-accessible instructions which, when accessed by a machine, cause the machine to:
perform the method of claim 20.

49. The article of manufacture of claim 48 further bearing instructions which, when accessed by the machine, cause the machine to:
perform the method of claim 24.

50. An article of manufacture bearing machine-accessible instructions which, when accessed by a machine, cause the machine to:
perform the method of claim 26.

51. The article of manufacture of claim 50 further bearing instructions which, when accessed by the machine, cause the machine to:
perform the method of claim 35.

52. A business method comprising:
publishing an identification of a block of data, the data including at least one of audio and video data;
receiving a plurality of instances of the block from a plurality of persons;
creating a golden master of the block by selectively extracting best sub-clips from the plurality of instances of the block; and
rewarding at least one of the persons.

53. The business method of claim 52 wherein the rewarding comprises:
making a financial payment to at least one of the persons, from whose instance of the block at least one sub-clip was extracted to the golden master.

54. The business method of claim 53 wherein:
the financial payment is made to a person from whose block a largest number of sub-clips were extracted to the golden master.
